(19) United States
(12) Patent Application Publication
(10) Pub. No.: US 2012/0278444 A1
(43) Pub. Date: Nov. 1, 2012

(54) Information Processing Apparatus

(75) Inventor: Hideki Ohkita, Kunitachi-shi (JP)

(73) Assignee: KABUSHIKI KAISHA TOSHIBA, Tokyo (JP)

(21) Appl. No.: 13/346,609

(22) Filed: Jan. 9, 2012

(30) Foreign Application Priority Data
Apr. 26, 2011 (JP) 2011-098302

(51) Int. Cl. G06F 15/16

(52) U.S. Cl. 709/219

(57) ABSTRACT

According to one embodiment, an information processing apparatus includes a first communication module, a second communication module, a server information acquisition module and a data providing module. The first communication module is configured to execute data communication with a server connected to the apparatus via a network. The second communication module is configured to execute proximity wireless communication with respect to an external device. The server information acquisition module is configured to acquire server information from the external device via the proximity wireless communication by the second communication module. The server information is various information items associated with servers accessible by the external device. The data providing module is configured to provide data managed on the server to the external device based on server information acquired by the server information acquisition module.

### CROSS-REFERENCE TO RELATED APPLICATIONS

This application is based upon and claims the benefit of priority from prior Japanese Patent Application No. 2011-098302, filed Apr. 26, 2011, the entire contents of which are incorporated herein by reference.

### FIELD

Embodiments described herein relate generally to a data providing technique of an information processing apparatus configured to efficiently transmit data managed on a sever with respect to an external device.

### BACKGROUND

In recent years, a method called a cloud computing method for performing a data process or data management by using a resource of a server connected via an Internet starts to be widely used. By utilizing the resource of the server, the client (who utilizes the resource of the server) can perform various data processes and manage a large amount of various content such as still image data and moving image data even if he does not independently have software or hardware.

Further, as the developed configuration of data management utilizing the resources of the server along with the appearance of devices having a greater affinity for Internet connection, a community (group) is formed by a plurality of clients who access the same server and data (content) is commonly used on the server only by the members of the community (group).

Further, recently, proximity wireless communication in which various content such as document data, image data and audio data can be transmitted between devices simply by setting the devices close to each other starts to be widely used. For example, if content that are desired to be transmitted are previously selected on device A, the target content can be transmitted from device A to device B simply by “holding” device A over device B (or vice versa).

It is now considered that user A who uses an information processing apparatus including a proximity wireless communication function provides content to be uploaded to the server and managed to user B. User B also uses an information processing apparatus including a proximity wireless communication function. In this case, user A downloads the target content from the server and fetches the same in his own apparatus to set a state in which the to-be-transmitted content is present in his own apparatus. Then, his own apparatus is set close to the information processing apparatus of user B to transmit the content to the information processing apparatus of user B via proximity wireless communication.

When user B also utilizes the server which user A utilizes for content management, the content can be provided from user A to user B simply by commonly using the content on the server even if the content is not transmitted. By commonly using the content, for example, a transmission time can be reduced and a storage consumption amount can be reduced on both of the provider side and receiver side of the content.

Based on the above condition, a mechanism for adequately selecting the content provision procedure according to the utilization situation of the servers on both of the provider side and receiver side of the content to efficiently perform transmission of the content between clients by performing the single operation of setting the devices close to each other is required.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an appearance of an information processing apparatus of a first embodiment.

FIG. 2 is an exemplary conceptual view for illustrating a communication function of a first communication module provided in the information processing apparatus of the first embodiment.

FIG. 3 is an exemplary conceptual view for illustrating a communication function of a second communication module provided in the information processing apparatus of the first embodiment.

FIG. 4 is an exemplary block diagram showing a system configuration of the information processing apparatus of the first embodiment.

FIG. 5 is an exemplary view schematically showing the flow of a process in a case where content can be commonly used on a cloud between an external device (another information processing apparatus) and the information processing apparatus of the first embodiment.

FIG. 6 is an exemplary view schematically showing the flow of a process in a first case where content cannot be commonly used on a cloud between an external device (another information processing apparatus) and the information processing apparatus of the first embodiment.

FIG. 7 is an exemplary view schematically showing the flow of a process in a second case where content cannot be commonly used on a cloud between an external device (another information processing apparatus) and the information processing apparatus of the first embodiment.

FIG. 8 is an exemplary view schematically showing the flow of a process in a third case where content cannot be commonly used on a cloud between an external device (another information processing apparatus) and the information processing apparatus of the first embodiment.

FIG. 9 is an exemplary flowchart for illustrating the processing procedure of the information processing apparatus of the first embodiment at the time of content provision.

FIG. 10 is an exemplary flowchart for illustrating the processing procedure of the information processing apparatus of the first embodiment at the time of content reception.

FIG. 11 is an exemplary block diagram showing a system configuration of an information processing apparatus of a second embodiment.

FIG. 12 is an exemplary view schematically showing the flow of a process in a case where content cannot be commonly used on a cloud between an external device (another information processing apparatus) and the information processing apparatus of the second embodiment and uploading can be performed between the clouds.

FIG. 13 is an exemplary flowchart for illustrating the processing procedure of the information processing apparatus of the second embodiment at the time of content provision.

FIG. 14 is an exemplary flowchart for illustrating the processing procedure of the information processing apparatus of the second embodiment at the time of content reception.

### DETAILED DESCRIPTION

Various embodiments will be described hereinafter with reference to the accompanying drawings.

In general, according to one embodiment, an information processing apparatus includes a first communication module, a second communication module, a server information acquisition module and a data providing module. The first communication module is configured to execute data communication with a server connected to the apparatus via a network. The second communication module is configured to execute proximity wireless communication with respect to an external device. The server information acquisition module is configured to acquire server information from the external device via the proximity wireless communication by the second communication module. The server information is various information items associated with servers accessible by the external device. The data providing module is configured to provide data managed on the server to the external device based on server information acquired by the server information acquisition module.

### First Embodiment

First, a first embodiment is explained.

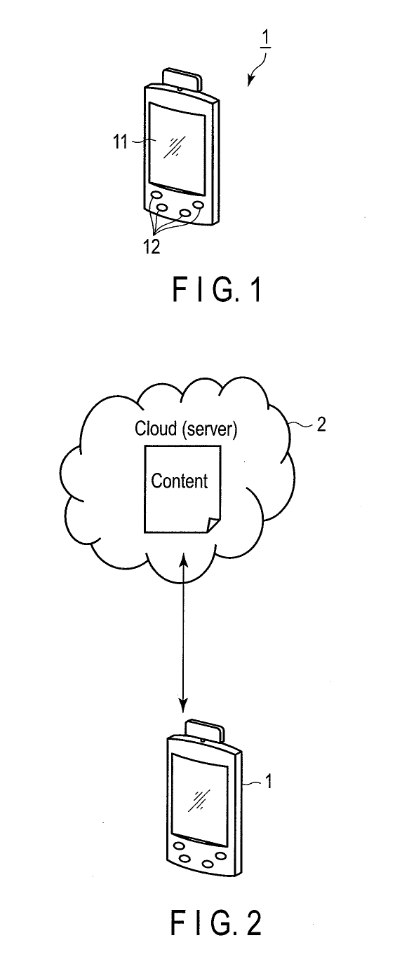

FIG. 1 is an exemplary view showing an appearance of an information processing apparatus 1 of this embodiment. For example, the information processing apparatus 1 is realized as a mobile information terminal that can be battery-driven such as a PDA (Personal digital assistant), smart phone or the like.

As shown in FIG. 1, the information processing apparatus 1 has a thin box-shaped casing and a display module 11 and operation module 12 are arranged on the front surface of the casing. For example, the display module 11 is configured by an LCD (liquid crystal display). The operation module 12 is configured by a power source switch for turning on/off the power source of the information processing apparatus 1, a key button used for performing an operation according to the display content of the display module 11, pointing device and the like. Further, a touch panel can be superposed on the LCD as one element of the operation module 12 to permit the user to directly perform an operation according to the display content of the display module 11 on the display screen.

FIG. 2 is an exemplary conceptual view for illustrating a communication function of a first communication module provided in the information processing apparatus 1 of this embodiment.

First, the information processing apparatus 1 includes a first communication module configured to perform wired LAN (Local area network) communication corresponding to an IEEE802.3 standard, for example, or wireless LAN communication corresponding to an IEEE802.11n standard, for example. The user of the information processing apparatus 1 can browse a Web page disclosed on the Internet and transmit an electronic mail via the Internet by means of the first communication module, for example. Further, various data processes can be performed (without independently having software and hardware) and a large amount of content can be managed by utilizing a resource of the server on the Internet that is called a cloud.

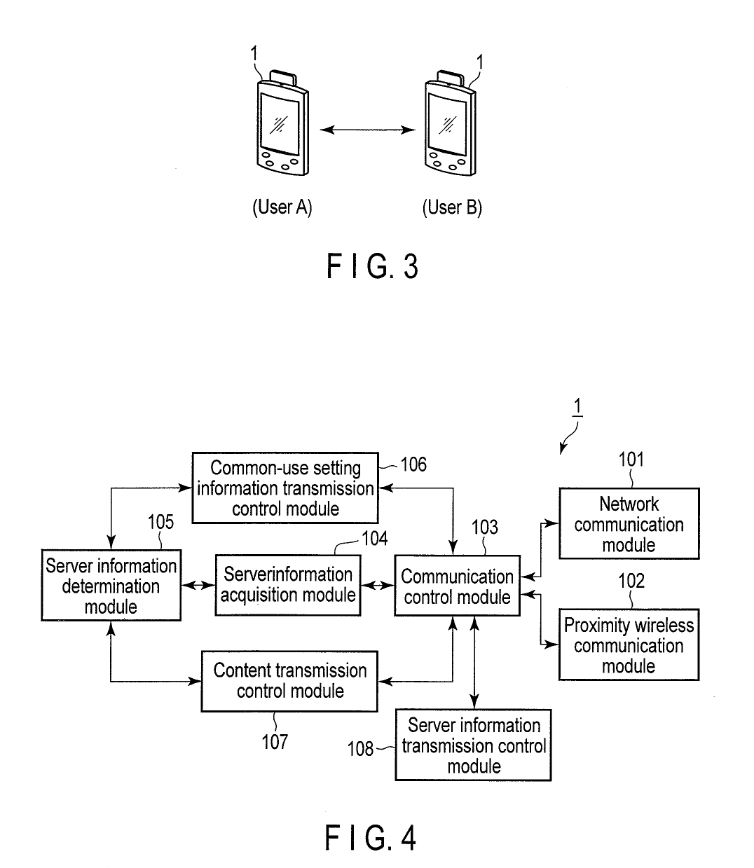

FIG. 3 is an exemplary conceptual view for illustrating a communication function of a second communication module provided in the information processing apparatus 1 of this embodiment.

Secondly, the information processing apparatus 1 includes a second communication module configured to perform proximity wireless communication. As a proximity wireless communication system, for example, TransferJet can be used. TransferJet is a proximity wireless communication system utilizing UWB (Ultra wideband) and can realize fast data transmission.

The user of the information processing apparatus 1 can transmit various content with respect to an external device including the proximity wireless communication function simply by setting both of the devices close to each other by use of the second communication module.

It is now assumed that user A provides content updated to a cloud 2 and managed to user B. In this case, if attention is paid to the cloud 2, two cases can be considered; a case (1) in which content can be commonly used with user B on the cloud 2 and a case (2) in which content cannot be commonly used with user B on the cloud 2. In the case (1), the content can be provided simply by commonly using the content on the cloud 2 even if the content is not transmitted via the proximity wireless communication. Therefore, the information processing apparatus 1 of this embodiment realizes the operation of efficiently transmitting content by seamlessly linking the proximity wireless communication with cloud computing and this content is explained in detail below.

FIG. 4 is an exemplary block diagram showing a system configuration of the information processing apparatus 1 of this embodiment.

As shown in FIG. 4, the information processing apparatus 1 includes a network communication module 101, proximity wireless communication module 102, communication control module 103, server information acquisition module 104, server information determination module 105, common-use setting information transmission control module 106, content transmission control module 107 and server information transmission control module 108. The network communication module 101 is a module for accessing the server on the cloud 2, that is, the first communication module described before. Further, the proximity wireless communication module 102 is a module for performing proximity wireless communication with respect to an external device (another information processing apparatus 1), that is, the second communication module described before.

In the information processing apparatus 1 on the side (user A) that is required to transmit content, if the communication control module 103 detects a connection made by use of the proximity wireless communication module 102, the server information acquisition module 104 acquires server information from a partner device (information processing apparatus 1 of user B) via the proximity wireless communication module 102. Server information acquired by use of the server information acquisition module 104 is informed to the server information determination module 105 and the content thereof is determined. In the server information, for example, identification information of the cloud 2 to which the partner device can access or the like is contained.

As the determination result, if it is determined that content can be commonly used on the cloud 2, the server information determination module 105 issues an instruction to the common-use setting information transmission control module 106 to transmit information (common-use setting information) required when the partner device requires the cloud 2 to provide content to be commonly used. For example, the common-use setting information is a URL (Uniform Resource Locator) indicating the storage location of the content. Further, a case where content can be commonly used on the cloud 2 typically indicates a case where the partner device can access the same cloud 2.

As the determination result, if it is determined that content cannot be commonly used, the server information determination module 105 issues an instruction to the content transmission control module 107, downloads content from the cloud 2 via the network communication module 101 under control of the content transmission control module 107 and transmits the same to the partner device via the proximity wireless communication module 102.

The information processing apparatus 1 on the side (user B) that is required to receive content first responds to a server information transmission request from the partner device (information processing apparatus 1 of user A) after a connection by the proximity wireless communication module 102 is made to acquire server information from the server on the cloud 2 via the network communication module 101 under control of the server information transmission control module 108 and send back the same to the partner device via the proximity wireless communication module 102. After this, if the proximity wireless communication module 102 receives a request from the partner device, the process is switched according to the request content.

When common-use setting information is received from the partner device, the communication control module 103 issues an instruction to the common-use setting information transmission control module 106 to issue a request for common-use content to the server (indicated by common-use setting information) on the cloud 2 via the network communication module 101 under control of the common-usage setting information transmission control module 106. Further, when content is received from the partner device, the content transmission control module 107 uploads the content to the server on the cloud 2 via the network communication module 101 as required.

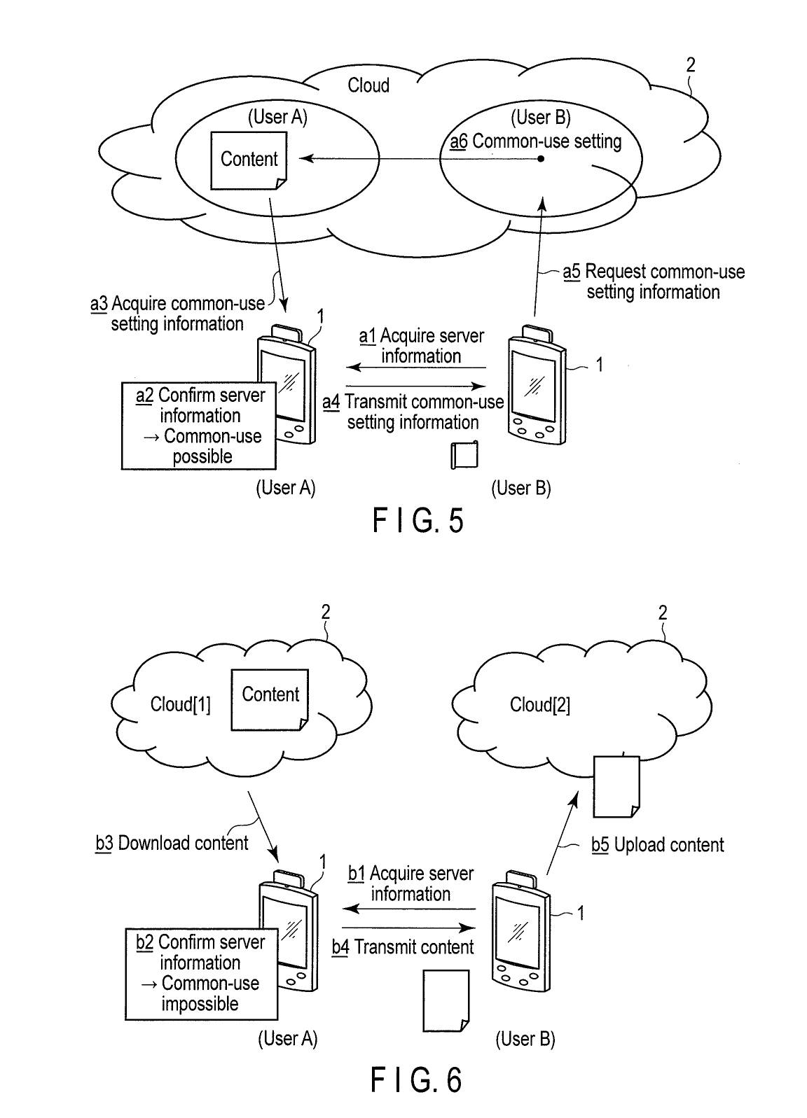

FIG. 5 is an exemplary view schematically showing the flow of a process in a case where content can be commonly used on the cloud 2 between the external device (another information processing apparatus 1) and the information processing apparatus 1 of this embodiment.

After a connection of proximity wireless communication is made, the information processing apparatus 1 on the transmission side acquires server information from the information processing apparatus 1 on the reception side (“a1” of FIG. 5) and confirms the acquired server information (“a2” of FIG. 5). As the confirmation result, if it is determined that the information can be commonly used on the cloud 2, the information processing apparatus 1 on the transmission side acquires common-use setting information of content from the server of the cloud 2 (“a3” of FIG. 5) and transmits the acquired common-use setting information to the information processing apparatus 1 on the partner side (“a4” of FIG. 5).

The information processing apparatus 1 on the reception side issues a request for common-use setting of content to the server of the cloud 2 by use of the received common-use setting information (“a5” of FIG. 5). In response to the request, the server of the cloud 2 performs a process of creating a link with respect to content indicated by the common-use setting information (“a6” of FIG. 5). As a result, the content can be commonly used. As link information, for example, the URL described before is used.

FIG. 6 is an exemplary view schematically showing the flow of a process in a first case where content cannot be commonly used on the cloud 2 between the external device (another information processing apparatus 1) and the information processing apparatus 1 of this embodiment.

It is assumed that the information processing apparatus 1 on the transmission side acquires server information from the information processing apparatus 1 on the reception side (“b1” of FIG. 6), confirms the acquired server information (“b2” of FIG. 6) and it is determined as the confirmation result that the clouds 2 used by both of the apparatuses are different and the content cannot be commonly used on the cloud 2. Then, the information processing apparatus 1 on the transmission side downloads content from the cloud 2 which the apparatus itself uses (“b3” of FIG. 6) and transmits the content to the information processing apparatus 1 on the reception side via proximity wireless communication (“b4” of FIG. 6). Further, the information processing apparatus 1 on the reception side uploads the received content to the cloud 2 used by the apparatus itself as required (“b5” of FIG. 6).

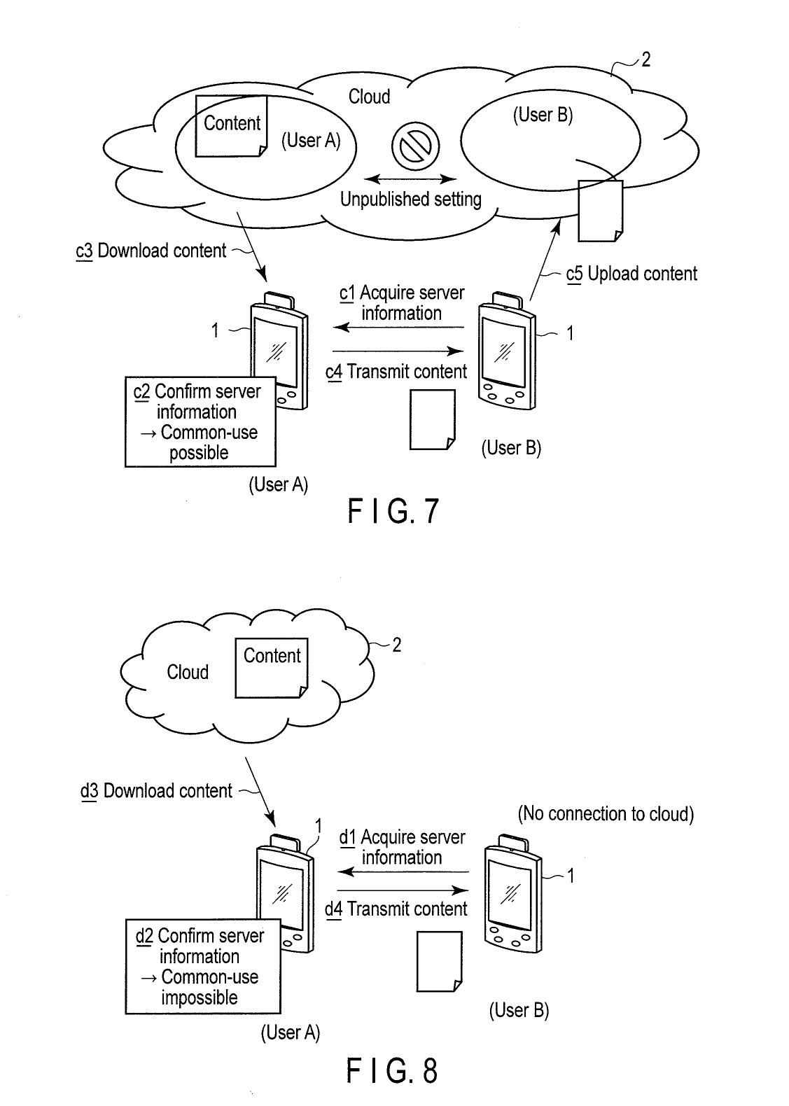

FIG. 7 is an exemplary view schematically showing the flow of a process in a second case where content cannot be commonly used on the cloud 2 between the external device (another information processing apparatus 1) and the information processing apparatus 1 of this embodiment.

In the explanation made with reference to FIG. 6, a case where it is determined that the content cannot be commonly used on the cloud 2 since the clouds 2 used by the information processing apparatus 1 on the transmission side and the information processing apparatus 1 on the reception side are different is shown. On the other hand, in this example, a case is provided in which the clouds 2 used by the information processing apparatus 1 on the transmission side and the information processing apparatus 1 on the reception side are common. However, for example, since content public setting of user A that is an account on the cloud 2 does not permit access from user B, it is determined that the content cannot be commonly used on the cloud 2.

Content common-use setting is made according to the specification of the server of each cloud 2. For example, there is a method for limiting the public range by use of a Privacy Setting, making the access right to unpublished content by use of a Guest Pass public only for a specified user, and setting a group called Contact and permitting a user to refer to the content if the user is a member of the group.

Also, in this case, the flow of the process is the same as that shown in FIG. 6. That is, the information processing apparatus 1 on the transmission side acquires server information from the information processing apparatus 1 on the reception side (“c1” of FIG. 7) and confirms the server information (“c2” of FIG. 7). As the confirmation result, if it is determined that content cannot be commonly used on the cloud 2, the information processing apparatus 1 on the transmission side downloads content from the cloud 2 (“c3” of FIG. 7) and transmits the content to the information processing apparatus 1 on the reception side via proximity wireless communication (“c4” of FIG. 7). Further, the information processing apparatus 1 on the reception side uploads the received content to the cloud 2 as required (“c5” of FIG. 7).

Content common-use setting on the cloud 2 is not generally open to the public in many cases and even in a case where it is open only to the group member, a case where it is required to commonly use specified content with a user other than the member may occur depending on the situation. The information processing apparatus 1 perform transmission of content in which proximity wireless communication and common-use content on the cloud 2 are seamlessly linked. Hence, the information processing apparatus 1 allows user to transmit content to the partner by a simple operation for proximity wireless communication of “holding” the devices over each other even when file common-use on the cloud 2 cannot be made by the limitation of common-use setting.

FIG. 8 is an exemplary view schematically showing the flow of a process in a third case where content cannot be commonly used on the cloud 2 between the external device (another information processing apparatus 1) and the information processing apparatus 1 of this embodiment.

In the explanation made with reference to FIG. 6, a case where it is determined that the content cannot be commonly used on the cloud 2 since the clouds 2 used by the information processing apparatus 1 on the transmission side and the information processing apparatus 1 on the reception side are different is shown. Further, in the explanation made with reference to FIG. 7, a case where it is determined that the content cannot be commonly used on the cloud 2 due to the limitation of common-use setting although the clouds 2 used by the information processing apparatus 1 on the transmission side and the information processing apparatus 1 on the reception side are common is shown. On the other hand, in this example, a case wherein the specification or setting is made in which the information processing apparatus 1 on the reception side cannot be originally connected to the cloud 2 is shown.

Even in this case, since the information processing apparatus 1 on the transmission side determines that content cannot be commonly used on the cloud 2, content are transmitted via proximity wireless communication (“d1” to “d4” of FIG. 8). However, since the information processing apparatus 1 on the reception side does not include a server to which content should be uploaded, it only stores the content in its own storage and does not perform the upload process for the content.

As described above, a case wherein content can be commonly used on the cloud 2 with the external device (another information processing apparatus 1) shown in FIG. 5 and a case wherein content cannot be commonly used on the cloud 2 with the external device (another information processing apparatus 1) shown in FIG. 6, FIG. 7 and FIG. 8 are provided. Even in the above cases, the user of the information processing apparatus 1 of this embodiment can perform an efficient procedure of providing target content to the external device simply by performing a single operation of proximity wireless communication for setting the devices closer to each other without paying any attention to the above problem.

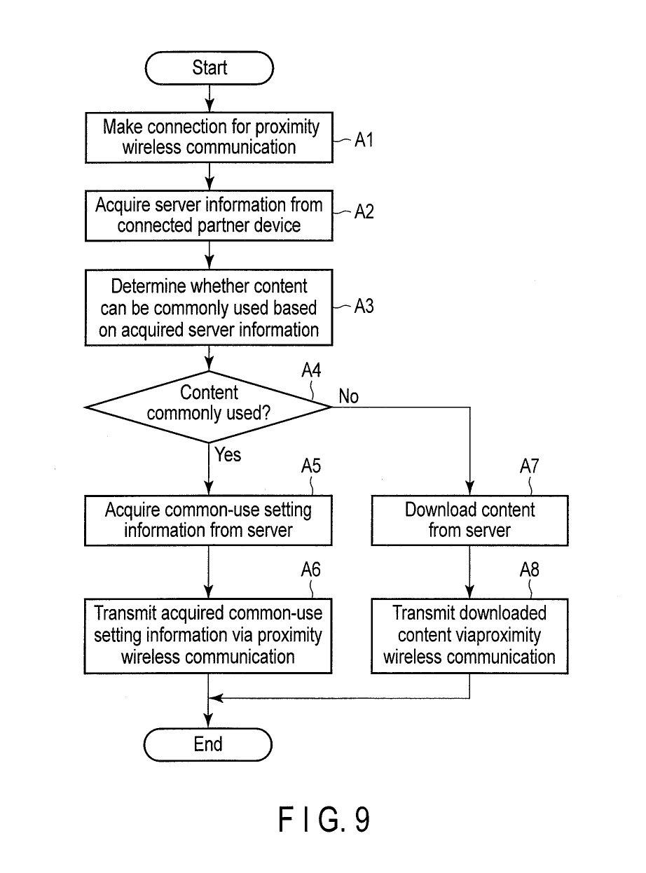

FIG. 9 is an exemplary flowchart for illustrating the processing procedure of the information processing apparatus 1 of this embodiment at the time of content provision.

At the content provision time, the information processing apparatus 1 makes a connection for proximity wireless communication (block A1) and then acquires server information from the connected partner device (block A2). The information processing apparatus 1 determines whether or not content can be commonly used with the connected partner device based on the acquired server information (block A3).

If it is determined that content can be commonly used (YES in block A4), the information processing apparatus 1 acquires common-use setting information from the server of the cloud 2 (block A5) and transmits the same to the connected partner device via proximity wireless communication (block A6).

If it is determined that content cannot be commonly used (NO in block A4), the information processing apparatus 1 downloads content from the server of the cloud 2 (block A7) and transmits the same to the connected partner device via proximity wireless communication (block A8).

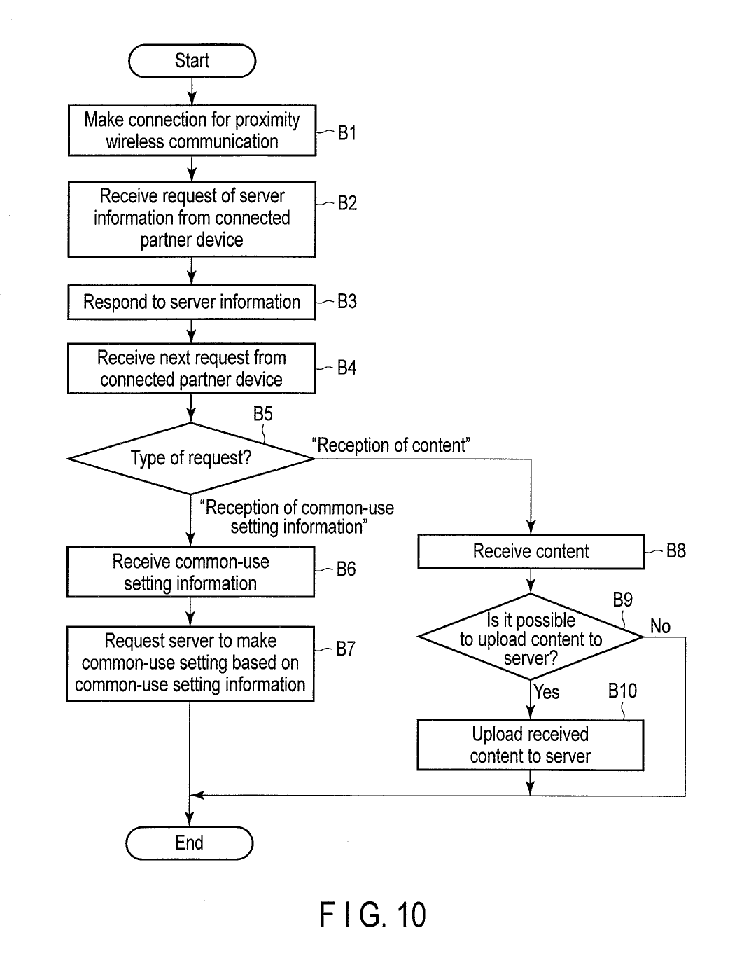

FIG. 10 is an exemplary flowchart for illustrating the processing procedure of the information processing apparatus 1 of this embodiment at the time of content reception.

At the content reception time, the information processing apparatus 1 makes a connection for proximity wireless communication (block B1) and then receives a request of server information from the connected partner device (block B2). The information processing apparatus 1 transmits server information to the connected partner device in response to the request (block B3) and waits for reception of a next request from the connected partner device (block B4). Subsequently, when receiving a next request, the information processing apparatus 1 determines the type of the request (block B5).

If the request content is “reception of common-use setting information”, the information processing apparatus 1 receives common-use setting information (block B6) and requests the server of the cloud 2 to make common-use content setting based on the received common-use setting information (block B7).

If the request content is “reception of content”, the information processing apparatus 1 receives content (block B8) and uploads the received content (block B10) when the content can be uploaded to the server of the cloud 2 (YRS in block B9). It is determined that content cannot be uploaded to the server of the cloud 2, for example, in a case where access to the server cannot be made due to an environmental condition such as breakage of the network in addition to a case where the function or setting of server access is not originally provided in the information processing apparatus 1 as described before.

As described before, the information processing apparatus 1 of this embodiment realizes a mechanism of adequately selecting the content provision procedure according to the utilization situation of the servers on both of the content provision side and reception side and efficiently transmitting content between the clients by performing a single operation for setting the devices close to each other. That is, the operation of efficiently transmitting content can be performed by seamlessly linking proximity wireless communication with cloud computing.

### Second Embodiment

Next, a second embodiment is explained.

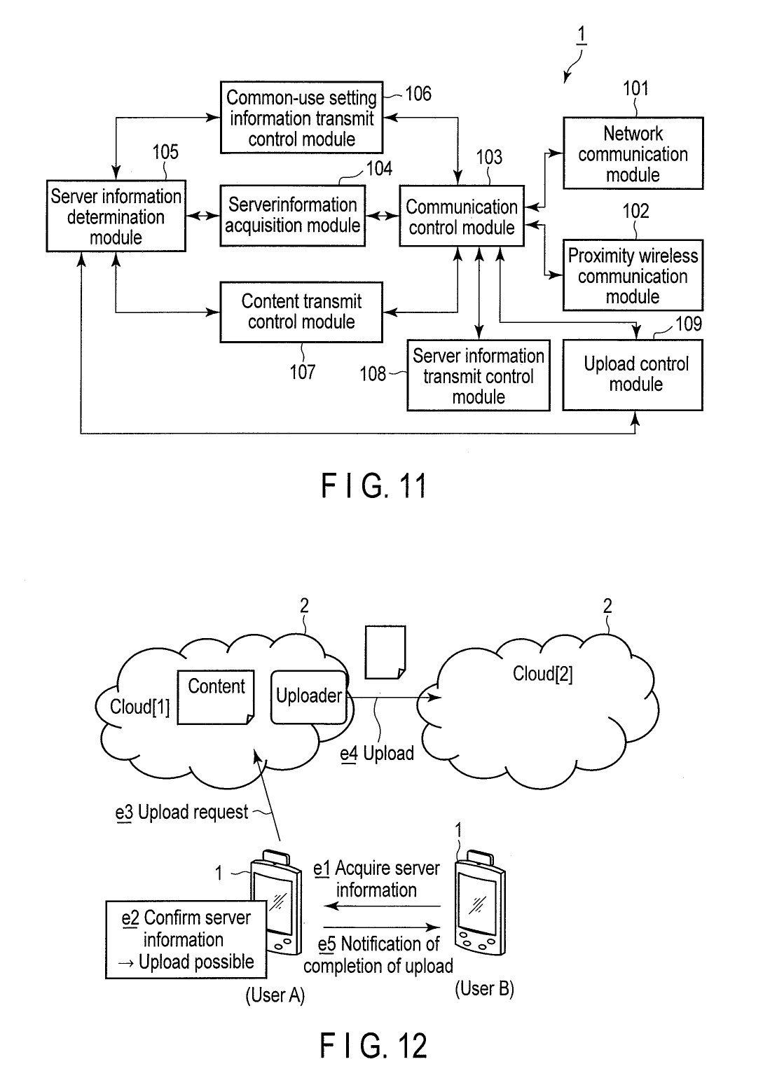

FIG. 11 is an exemplary block diagram showing a system configuration of an information processing apparatus 1 of this embodiment.

As shown in FIG. 11, the system configuration thereof is different from that of the information processing apparatus 1 (shown in FIG. 4) in that the information processing apparatus 1 of this embodiment further includes an upload control module 109. In the first embodiment, if the clouds 2 used by the information processing apparatus 1 on the transmission side and the information processing apparatus 1 on the reception side are different, it is determined that content cannot be commonly used on the cloud 2 and the content are transmitted. On the other hand, in this embodiment, the content provision procedure is finely divided based on whether or not an uploading operation between the clouds 2 can be performed.

Generally, content cannot be commonly used between the servers of the different clouds 2, but content can be uploaded from the server of one of the clouds 2 to the server of the other cloud 2 by use of a plug-in function in some cases. In this embodiment, when an uploading operation between the clouds 2 can be performed by use of the above function, content can be provided without transmitting the content via proximity wireless communication.

FIG. 12 is an exemplary view schematically showing the flow of a process in a case where content cannot be commonly used on the cloud 2 between an external device (another information processing apparatus 1) and the information processing apparatus of this embodiment and uploading can be performed between the clouds 2.

The information processing apparatus 1 on the transmission side receives server information from the information processing apparatus 1 on the reception side (“e1” of FIG. 12) and confirms the acquired server information (“e2” of FIG. 12). Then, it is assumed that the clouds 2 used by both of the apparatuses are different and it is determined that content cannot be commonly used on the cloud 2 but, for example, it is detected that a plug-in such as PicasaUploader can be used and content uploading via the server can be performed. Then, the information processing apparatus 1 on the transmission side instructs content uploading via the server (to the cloud 2 used by the information processing apparatus 1 on the reception side) with respect to the server of the cloud 2 used by the apparatus itself instead of transmitting the content (“e3” of FIG. 12). Then, after completion of content uploading via the server (“e4” of FIG. 12), the information processing apparatus 1 on the transmission side informs completion of uploading to the information processing apparatus 1 on the reception side via proximity wireless communication (“e5” of FIG. 12) and terminates the process associated with content provision.

Thus, the information processing apparatus 1 of this embodiment further enhances the efficiency of transmitting the target content between the devices.

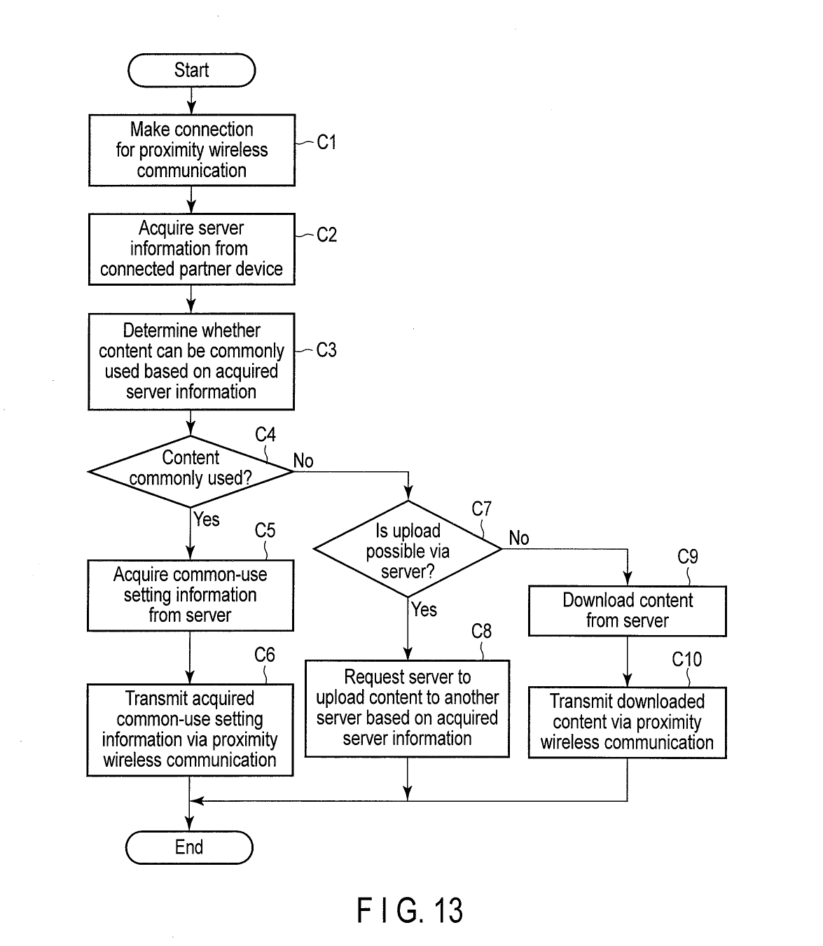

FIG. 13 is an exemplary flowchart for illustrating the processing procedure of the information processing apparatus of this embodiment at the time of content provision.

The process of block C1 to block C6 of FIG. 13 is the same as the process of block A1 to A6 of FIG. 9, and therefore, the explanation thereof is omitted. If it is determined in block C4 that content cannot be commonly used, the information processing apparatus 1 of this embodiment determines whether or not uploading can be performed via the server between the clouds 2 (block C7). If uploading can be performed (YES in block C7), it instructs content uploading via the server based on server information acquired from a connected partner device with respect to the server of the cloud 2 which the apparatus itself uses (block C8).

If it is determined that uploading via the server cannot be performed (NO in block C7), the information processing apparatus 1 downloads content from the server of the cloud 2 (block C9) and transmits the same to the connected partner device via proximity wireless communication (block C10).

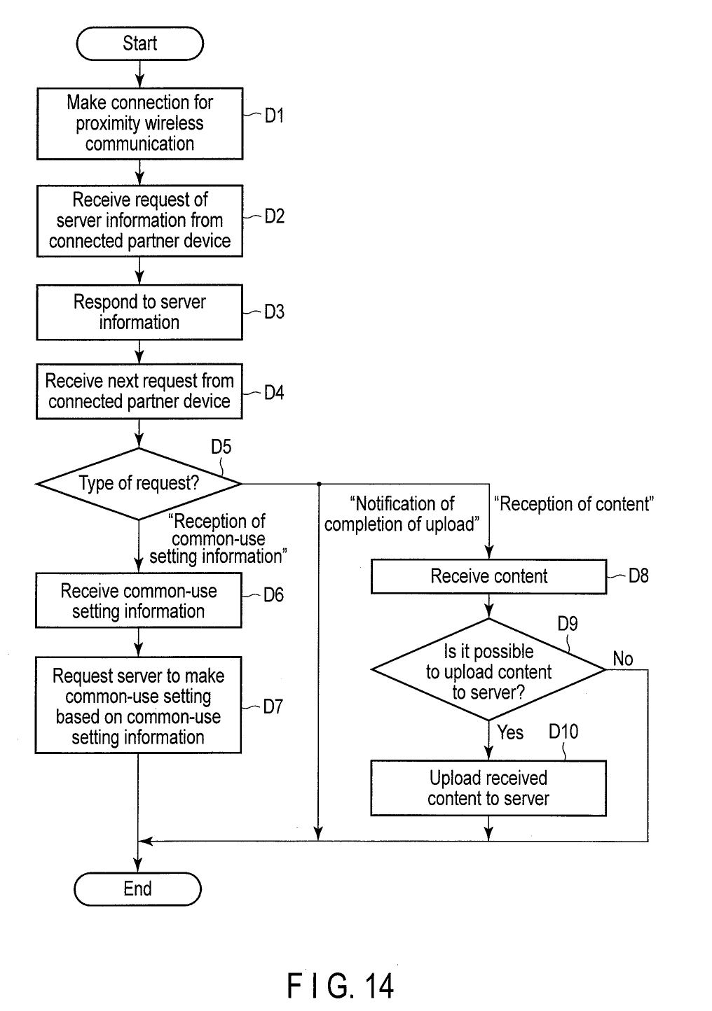

FIG. 14 is an exemplary flowchart for illustrating the processing procedure of the information processing apparatus 1 of this embodiment at the time of content reception.

The processing procedure is different from the processing procedure in the first embodiment shown in FIG. 10 in that “notification of upload completion” is included in a next request that can be received from the connected partner device. The information processing apparatus 1 determines the type of a request received from the connected partner device (block D5) and terminates the process associated with reception of content as it is if the request content is “notification of upload completion”.

As described above, in the information processing apparatus 1 of this embodiment, a mechanism for adequately selecting the content provision procedure according to the utilization situation of the servers on both of the content provision side and reception side and efficiently transmitting content between the clients by performing a single operation for setting the devices close to each other is realized. That is, the operation of efficiently transmitting content can be performed by seamlessly linking proximity wireless communication with cloud computing.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first communication module configured to communicate with a first server via a network;
a second communication module configured to wirelessly communicate with an external device;
a server information acquisition module configured to acquire server information from the external device via the second communication module, the server information comprising various information items associated with servers accessible by the external device; and
a data providing module configured to provide data managed on the first server to the external device based on server information acquired by the server information acquisition module.

2. The apparatus of claim 1, wherein the data providing module comprises:
a determination module configured to determine whether data is commonly used with the external device on the first server based on the server information acquired by the server information acquisition module; and
a common-use setting information transmission module configured to transmit common-use setting information to the external device via the second communication module when the determination module determines that data is commonly used, the common-use setting information permitting the external device to commonly use data managed on the first server.

3. The apparatus of claim 2, wherein the common-use setting information comprises a URL (Uniform Resource Locator).

4. The apparatus of claim 2, wherein the data providing module further comprises a data transmission module configured to download data managed on the first server via the first communication module when the determination module determines that data on the first server is not commonly used with the external device, and to transmit the downloaded data to the external device via the second communication module.

5. The apparatus of claim 2, wherein the determination module is configured to determine that data is commonly used when a second server used for management of data is accessible by the external device.

6. The apparatus of claim 2, wherein the determination module is configured to determine that data is commonly used when the external device is permitted to access the first server used for management of the data and when the external device is permitted to access data managed on the first server.

7. The apparatus of claim 2, wherein the determination module is configured to determine that data is not commonly used when a server accessible by the external device does not exist.

8. The apparatus of claim 1, wherein the data providing module comprises:
a determination module configured to determine whether data is permitted to be uploaded from a first server used for management of the data to a second server accessible by the external device based on the server information acquired by the server information acquisition module; and
a data uploading module configured to issue via the first communication module a request to upload data from the first server used for management of the data to the second server accessible by the external device when the determination module determines that data is permitted to be uploaded between the servers, and to transmit a notification of completion of data uploading between the servers to the external device via the second communication module after the notification of completion of data uploading between the servers is received via the first communication module.

9. The apparatus of claim 8, wherein the data providing module further comprises a data transmission module configured to download data managed on the first server via the first communication module when the determination module determines that data uploading between the servers is impossible, and to transmit the downloaded data to the external device via the second communication module.

10. An information processing apparatus comprising:
a first communication module configured to execute data communication with a first server via a network;
a second communication module configured to execute wireless communication with an external device;
a server information transmission module configured to transmit server information to the external device via the second communication module in response to a request from the external device, the server information comprising various information items associated with servers accessible by the apparatus;
a first data acquisition module configured to receive common-use setting information for commonly using data managed by the external device on the first server from the external device via the second communication module, and to download the data from the first server via the first communication module using the common-use setting information; and
a second data acquisition module configured to receive the data from the external device via the second communication module.

11. The apparatus of claim 10, further comprising an automatic data uploading module configured to upload the data received by the second data acquisition module to the first server via the first communication module.

12. The apparatus of claim 10, wherein the common-use setting information comprises a URL (Uniform Resource Locator).
